(19) United States
(12) Patent Application Publication
(10) Pub. No.: US 2022/0072365 A1
(43) Pub. Date: Mar. 10, 2022

(54) DEVICE FOR EXERCISING THE BODY IN A CONTINUAL AND CONTROLLED MANNER

(71) Applicant: Hugo ARNADO NEGRETE, Concepción (CL)

(72) Inventor: Hugo ARNADO NEGRETE, Concepción (CL)

(21) Appl. No.: 17/419,851

(22) PCT Filed: Dec. 30, 2019
(86) PCT No.: PCT/CL2019/050162

§ 371 Date: Jun. 30, 2021

(30) Foreign Application Priority Data
Feb. 25, 2019 (CL) 0504-2019

(51) Int. Cl. A63B 23/02; A63B 21/00; A63B 21/005

(52) U.S. Cl. CPC A63B 23/0211; A63B 23/0244; A63B 21/4001; A63B 21/0058; A63B 21/4031

(57) ABSTRACT

The present utility model relates to a device for the assisted exercise of the abdominal muscles. The equipment comprises a base structure, a seat for a person, a back for the torso, a fastening device for the arms, an adaptable headrest cushion and a foot rest. This configuration ensures that the physical force is exerted by the abdominal muscles and the arms. The device comprises a central rotation shaft connected to a variable-power electric motor connected to a reducer.

### FIELD OF THE INVENTION

The present invention relates to an industrially manufactured device for mechanical exercising to burn out the body fat. Specifically, it is oriented to all people, without age or physical condition restrictions, obtaining results with minimum effort in a short time.

### BACKGROUND OF THE INVENTION

That Currently, available equipment has been based on a manual operation with the addition of weight. This technology and design forces other muscles to work, resulting, several times, in lesions or diminishing the exercise effectiveness.

Faced with this problem, we propose a design which is based on a mechanical and automated operation, allowing to exercise abdominals and other body muscles in a range between 15 and 72 per minute. Thus, making minimal physical efforts due to its mechanical characteristic, avoiding lesions, and helping to increase bodily exercise. The main difference is that this machine (device) uses a motor to drive the human body to apply force with their own muscles; therefore, the motor must be adjusted while working in kinesthetic medical activities. The machine (device) differs from others in that its purpose is not only to remove excess weight or develop fitness in users, it is also therapeutic and it uses the motor to avoid that another person exertsa force on the patient.

There are several known abdominal exercise equipment based on manual operation with the addition of weight. The used design and technology forces to work other muscles, which often result in injuries or leads to a decrease in the exercise effectiveness; that forces users to perform fewer physical training cycles, mainly in older people, who are prone to neck and spine injuries, obtaining results in a period of time with less effectiveness.

The patent ES2593063T3 discloses a device for training a person's back and neck. A sports machine with weight addition, by not having an adequate weight control produces injuries in other muscles of the body; by working with weight, it decreases the number of exercise cycles, therefore providing results in a longer-term; and being a machine with weight addition is a limiting factor for older users.

Patent document P201331126 discloses a motorized machine for working the body's upper and lower extremities; the machine is composed of two motors, consuming, therefore, more energy. The machine works only the body's extremities; the lower (legs) and upper (clavicle, shoulder blades and arms) extremities, so it is a machine for specific exercises. And, the machine does not work the abdominal muscles, which are more challenging to exercise. The characteristics of the machine make it more similar to relaxation and stretching therapies such as Pilates.

Using the claims of P201331126, the following is refuted:
Claim 4 of the present invention, which describes a movable backrest that receives movement originating from the motor is opposed to claim 1 of P201331126, wherein it is specified that the backrest is static and mounted to the structure (or static drawer equivalent).
Claim 9 of the present invention, which describes a fixed seat for the support of the buttocks is opposed to claim 1 of P201331126 where it is specified that the user's buttocks rest on an extension of the fixed backrest, which highlights the differences between P201331126 and the present invention, regarding the moving parts and the force transmitting parts.
Claim 5 of the present invention, which describes a footrest fixed to the equipment, contrasts with claim 1 of P201331126, which specifies a simile called a leg rest that receives the movement of the motor utilizing a bearing, to perform stretching exercises; thus complementing the observation in the point above about the mobile and fixed parts between both machines.

Claim 2 of the present invention, which describes an arm support device fixed to the equipment, contrasts to claim 1 of P201331126 where a simile called armrest is specified, driven by a servomotor to perform muscular elongations of the upper extremities.

The Ab Cruncher Exercise Machine (https://www.youtube.com/watch?v=GaFVuSQWYHo), shows an abdominal machine, which consists of a system of movable rollers where the knees are positioned, to simulate the exercise of legs to the chest, it works the abdomen exclusively, a tremendous physical effort must be made to maintain the position required by the machine. It is risky for people with overweight due to the position of support of the elbows and knees.

In the case of Ab Roll Gyro Abdominal Machine Tvalue—Tutorial. Falabella TV (https://www.youtube.com/watch?v=tYI_44ga-UA). It shows an abdominal machine, with back pressure backwards, to return with the torso forward causing an abdominal exercise, working the abdomen exclusively, exerting backward pressure with the back can cause spinal injuries, compared to our device it is slower with respect to the results presented as a fitness product, it is not a fat burner, and in those terms does not apply to people with obesity.

In the case of Ab Tomic(https://www.youtube.com/watch?v=nahTfIPXgZO), marketed by Innova company, it shows a machine to work abdominals, legs, back and arms, where its use is through the use of physical strength, the machine does not provide stability to the body in the abdominal work, which may cause injuries in the lumbar spine. Its use is mainly for young usersdue to direct utilization of physical strength in the type of training proposed by Ab Tomic.

### SUMMARY OF THE INVENTION

That the air compressors to be used are of advanced technology and perform two functions at the same time:
1) They will compress atmospheric air, indicatively at 200 bar or more if necessary, and at the same time.
2) The compression-generated heat will be transferred to a cooling fluid, which can be either water or something else, such as refrigeration oil, via thermal exchangers that will intervene for each compression stage of each individual air compressor.

### BRIEF DESCRIPTION OF THE DRAWINGS

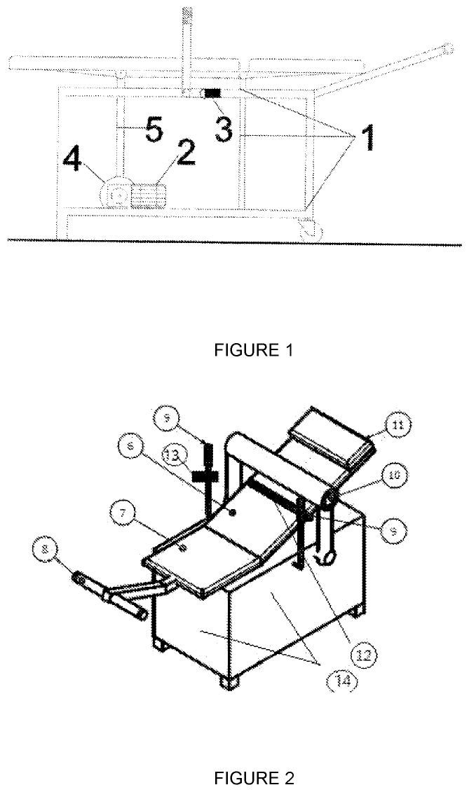

FIG. 1 shows the device to exercise the body's structure or side elevation configuration, in which:
1. Resistant supporting structure
2. Motor device
3. Energizing and de-energizing device for the motor system
4. Eccentric motion transmission device
5. Reciprocating motion transmission device.

FIG. 2 shows the device to exercise the body's structure or perspective view configuration, in which:
6. Movable backrest
7. Fixed seating
8. Footrest
9. Device for holding arms
10. Abdominal cushion
11. Headrest
12. Tether strap for human trunk
13. Human interface device or display device
14. Cladding panel

### DETAILED DESCRIPTION OF THE PREFERRED EMBODIMENTS

The present invention relates to a mechanical abdominal stretcher to exercise the body in a continuous and controlled manner protecting during its usage the spine, neck, and legs, resulting in an effective fat reduction, body fitness and providing medical therapy with the primary objective to improve the people's life quality with a comfortable and secure process. The device is composed of a supporting base structure (1), with a base frame and a top frame, an electric motor (2) mounted on the base frame, a device for energizing and de-energizing (3) the motor (2) power supply; an eccentric motion transmission device (4) which connects the motor, that provides the driving force, to a reciprocating motion transmission device (5), which connects to a movable backrest (6) that applies the lifting force; upon the action of this force assisted abdominal crunches, in cycles per minutes, of the musculoskeletal system, takes place, the movable backrest (6) is made of selected materials ensuring the user comfort and the required robustness. Said materials arrange in a convenient ergonomic design; a fixed seating device (7) fixed to the machine, have similar structural characteristics as the movable backrest (6); a footrest device (8) movable and adjustable, fixed to the machine, which in its upper position works on lower abdominals and in its lower position works the top abdominals, a device for holding arms (9) is made of resistant materials suitable for the load work and direct human contact, fixed to the machine; the apparatus abdominal cushion (10) is of adjustable height and can be adapted to different physiognomies; the headrest apparatus (11) can adapt to different heights, is composed mainly of padded type materials and coated with protective materials in compliance with the user's comfort; a human interface device or display device (13) provides exercises parameters and physiological statistics of a biomechanical nature.

1. Device for exercising the body in a continuous and controlled manner CHARACTERIZED in that it is composed of a supporting structure (1) having a base frame and a top frame; an electric motor (2) mounted on the base frame; a device for energizing and de-energizing (3) the power supply of the motor (2); an eccentric motion transmission device (4) that is connected to the motor (2) with the rotation function; a reciprocating motion transmission device (5) that is connected to the eccentric transmission mechanism (4); a movable backrest device (6) that applies the lifting force to the user; driven by the motor device (2), the eccentric motion transmission device (4) and the reciprocating motion transmission device (5); a fixed seating device (7), fixed to the supporting structure (1); a movable footrest device (8); a device for arm support (9) attached to the stretcher; optionally an abdominal cushion device (10) of variable height; a movable headrest device (11); a human interface device or display device (13) for monitoring time, cycles and burned calories.

2. Device for exercising the body in a continuous and controlled manner according to claim 1, CHARACTERIZED in that the supporting structure (1) is protected perimetrically by panels (14) of suitable materials to safeguard the user integrity and the continuity in operation of the mechanical system involved.

3. Device for exercising the body in a continuous and controlled manner according to claim 1, CHARACTERIZED in that the motor system (2) has adjustable speed.

4. Device for exercising the body in a continuous and controlled manner according to claim 1, CHARACTERIZED in that the movable backrest device (6) and the fixed seating (7) are made of ergonomic materials suitable for the user's comfort and structural resistance.

5. Device for exercising the body in a continuous and controlled manner according to claim 1, CHARACTERIZED in that the footrest device (8) is movable, adjustable and fixed to the machine, whose material of manufacture is resistant to the pressure exerted by the user.

6. Device for exercising the body in a continuous and controlled manner according to claim 1, CHARACTERIZED in that the device for holding arms (9) is constructed of resistant materials suitable for working loads and human contact.

7. Device for exercising the body in a continuous and controlled manner according to claim 1, CHARACTERIZED in that the headrest device (11) is adaptable to different physiognomies, consisting mainly of padding type material and covered with protective material in accordance with the padding, for the user comfort.

8. A device for exercising the body in a continuous and controlled manner according to claim 1, CHARACTERIZED in that the human interface device or display device (13) delivers exercise parameters and physiological statistics of a biomechanical nature.

9. Device for exercising the body in a continuous and controlled manner according to claim 1, CHARACTERIZED in that the movable backrest device (6) has attached to it a tether strap (12) that allows keeping the user's back fixed to the movable backrest (6) avoiding bumps of the back against the movable backrest (6).
